(19) United States
(12) Patent Application Publication
(10) Pub. No.: US 2024/0348097 A1
(43) Pub. Date: Oct. 17, 2024

(54) VEHICLE WHEEL WIRELESS POWER SYSTEM

(71) Applicant: Yank Technologies, Inc., Brooklyn, NY (US)

(72) Inventors: Joshua Aaron YANKOWITZ, Brooklyn, NY (US); Vinh CUN, Brooklyn, NY (US); Benjamin TEREBELO, Brooklyn, NY (US)

(21) Appl. No.: 18/685,176

(22) PCT Filed: Aug. 19, 2022
(86) PCT No.: PCT/US2022/075231

§ 371 Date: Feb. 20, 2024

Related U.S. Application Data
(60) Provisional application No. 63/260,467, filed on Aug. 20, 2021.

(51) Int. Cl. H02J 50/10; B60Q 1/32; B62J 43/30; H02J 7/34; H02J 50/40; H05B 47/19

(52) U.S. Cl. CPC H02J 50/10; B60Q 1/326; B62J 43/30; H02J 50/402; H05B 47/19; H02J 7/345

(57) ABSTRACT

A wireless power system for vehicle wheels is described. The system includes a magnetic field generator, e.g., a permanent magnet, embedded or disposed in a fixed position, e.g., in a wheel well or brake caliper(s), and a wireless power receiver embedded or disposed in a wheel rim or wheel trim. As the wheel rotates and receiver antenna(s) cross a flux path produced by the power transmitter, an alternating current signal is produced at the receiver, which is converted to a direct current signal, regulated, and delivered to various electronic components in the vehicle wheel. The received power can be used to charge a battery or power light emitting diodes (LEDs). A wireless communication module embedded in the vehicle wheel can be used to wirelessly control and monitor the electronic components, e.g., to change intensity or strobe periodicity of LEDs or monitor sensors.

### CROSS-REFERENCE TO RELATED APPLICATIONS

This patent document claims priority to and benefit from U.S. Provisional Patent Application No. 63/260,467, entitled “VEHICLE WHEEL WIRELESS POWER SYSTEM,” filed on Aug. 20, 2021, which is hereby incorporated by reference in its entirety.

### BACKGROUND

As modern vehicles continue to evolve and advance, vehicle lighting and electronic devices within and outside the vehicle are gaining more focus and attention. Lighting and other electronic devices, for example, on the exterior of the vehicle such as on the wheels provide better ambience, allow for more vehicle customization, and allow passengers and drivers more useful visual information. Wireless charging can be a means of providing power to lighting and electronic systems where physical wiring can be cumbersome. For vehicle wheels in particular, providing power to lighting and electronics can be challenging because of the complexity and expense of developing a wiring harness that can be physically connected to electronics in the vehicle's wheel while withstanding the high torque from the wheel's rotation and the harsh environmental conditions. There is therefore a need for a cost effective, simple, and durable solution for providing power to lighting and other electronics contained on, in, or near vehicle wheels.

### BRIEF DESCRIPTION OF THE DRAWINGS

Detailed descriptions of implementations of embodiments will be described and explained using the accompanying drawings.

FIG. 1 is a block diagram of a vehicle wheel wireless power system.

FIG. 2A illustrates a vehicle wheel structure containing a wireless power system.

FIG. 2B is an exploded view of a portion of the vehicle wheel structure of FIG. 2A.

FIGS. 3A, 3B, and 3C illustrate a vehicle wheel structure showing different positions of a wireless power receiver in relation to a magnetic field generator.

FIG. 4A illustrates a vehicle wheel structure showing a magnetic field generator embedded on wheel calipers.

FIG. 4B illustrates a vehicle wheel structure showing a wireless power receiver embedded in a vehicle's wheel rim.

FIG. 5A illustrates a wireless power receiver comprising two joined constituent parts.

FIG. 5B illustrates a wireless power receiver comprising a single part.

FIG. 6 illustrates a vehicle wheel structure containing multiple wireless power receivers.

FIG. 7 is a flowchart that illustrates generating power for electronic components in a vehicle wheel using a wireless power receiver coupled to a magnetic field generator.

FIG. 8 illustrates an example bicycle structure for use with the disclosed wireless power system.

FIG. 9 illustrates an example motorcycle structure for use with the disclosed wireless power system.

FIG. 10 illustrates an example mounting of a wireless power transmitter in the knuckle region of a vehicle.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

In one aspect of the disclosed technology a wireless power system for a vehicle wheel is disclosed. The wireless power system includes a movable or rotatable wireless power receiver embedded on or in the wheel and a magnetic field generator or wireless power transmitter located at a fixed position in the wheel well or brake calipers.

The transmitter unit (referred to throughout this description interchangeably as a magnetic field generator or wireless power transmitter) can include a fixed permanent magnet encapsulated in an enclosure adapted to protect the permanent management from environmental hazards, e.g., rain, vibration, sand, dirt, snow, etc. An electromotive force is induced across the wireless power receiver (or receiver(s)) when they rotate and cross the static magnetic flux path produced by the transmitter unit or magnetic field generator. The receiver in turn can then provide power to electronic components on the vehicle wheel (e.g., a battery, light emitting diodes (LEDs), etc.).

The wireless power receiver can be disposed in the wheel rim or wheel trim and includes receiver antennas to inductively couple to the power transmitter as the wheel rotates. The wireless power receiver can also include a receiver printed circuit board (PCB) coupled to the receiver antennas. The receiver PCB can include a bridge rectifier configured to convert an alternating current (AC) signal generated to a direct current (DC) signal, a regulator to regulate the DC signal, and a controller to control different aspects of the electronic devices.

In another aspect of the disclosed technology, the controller of the wireless power system can include a Bluetooth (BT), Bluetooth Low Energy (BLE), Long-Term Evolution (LTE), Wi-Fi, or 5G communication module configured to monitor or control the electronic components through a wireless communication device (e.g., a smartphone or tablet) or through the vehicle's infotainment system. For example, the controller can control actuators, LEDs, etc., or monitor sensors, via BT/BLE communication. The BT/BLE module can be contained in the wheel rim or wheel trim and can obtain power directly from the wireless power receiver or from an energy storage device (e.g., battery, capacitor, etc.) charged by the wireless power receiver. Direct control of the LEDs via wireless communication can provide for customizable LED illumination of the vehicle's wheels which can afford vehicle owners and passengers a customizable experience.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

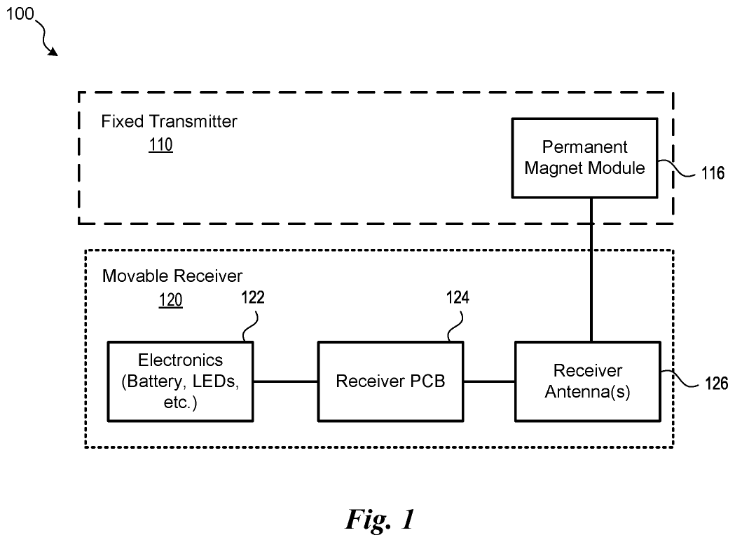

FIG. 1 is a block diagram of a vehicle wheel wireless power system 100. The wireless power system 100 (e.g., a wireless charging system) can provide power to electronics embedded or disposed on wheels, wheel rims, wheel trims, or other rotating apparatus in vehicles or other machinery. As will be described in further detail below, the disclosed technology provides a greater ability to customize and add electrical and electronic functionality to future vehicles.

Wireless power system 100 includes a fixed transmitter 110 (also referred to as a base/fixed/stationary unit) that can be mounted in or near the brake calipers of the vehicle or the vehicle's wheel well. An example mounting location near the brake calipers is on the knuckle region of the vehicle. The fixed transmitter 110 can include a permanent magnet module 116 that produces a static magnetic field that is captured by a movable receiver 120 as the vehicle's wheel rotates and crosses the path of the static field emanating from the permanent magnet. The permanent magnet module 116 can be embedded in the brake calipers or knuckle in the factory (e.g., by the original equipment manufacturer (OEM)) or it can be mounted onto the knuckle or brake calipers as an aftermarket accessory. The permanent magnet in the permanent magnet module 116 can be potted or encapsulated in an enclosure adapted to protect it from environmental hazards including rain, dirt, snow, dust, etc. In some implementations, an electromagnet can be used instead of or in addition to the permanent magnet.

The movable receiver 120 can include one or more receiver antennas 126, a receiver PCB 124, and one or more electronic components 122. The electronic components can include, for example, a battery, LEDs, communication modules, sensors, actuators, etc. The receiver antenna(s) couple with the fixed transmitter 110 converting an alternating current (AC) signal from the transmitter into a direct current (DC) signal using a bridge rectifier contained in the receiver PCB 124. The receiver PCB 124 can also include a voltage or current regulator, a control unit, and additional circuitry to provide regulated power to the other electronic components 122, for example, a battery buffer, or to provide regulated power directly to LEDs. The regulator can also clamp the voltage or current to control the battery charging and prevent overcharging and also provide a constant voltage or current regardless of the speed of rotation or angular velocity of the wheel (e.g., speed of the vehicle). In some embodiments, the receiver PCB 124 can include a flyback, buck, buck-boost, sepic, voltage regulator, and/or current monitoring unit.

The battery buffer can allow additional functionality for the wireless power vehicle wheel system. For example, without the battery buffer, LEDs powered by the wireless power receiver might only illuminate the wheel or vehicle while the wheel is in motion, i.e., when the wireless power receiver crosses the magnetic flux path produced by the magnetic field generator or transmitter unit. When the vehicle is stopped, there might be no power delivered to the LEDs. The battery can buffer the power and provide it to the electronic components whether or not the vehicle is in motion (whether or not the wheel is rotating). The battery buffer can also provide constant power (e.g., a constant current) to electronic components independent of the angular velocity of the wheel (e.g., allow for a constant intensity, luminosity, or brightness of the LEDs regardless of the speed of rotation of the wheel or the density of the flux coupling between the wireless transmitter and wireless receiver). In some implementations, the wireless power system can provide a few milliwatts to hundreds of milliwatts of power to the battery or the electronic components. In other implementations the system can provide watts of power depending on, for example, the number of turns of the receiver antenna and the strength of the magnetic field generator (e.g., strength of the permanent magnet).

In some implementations, the electronic components 122 can be included as part of the receiver PCB 124. The electronics in the receiver PCB 124 can include the LEDs.

In some implementations, the electronic components 122 or the receiver PCB 124 can also include a control unit which can include Bluetooth (BT), Bluetooth Low Energy (BLE), Long-Term Evolution (LTE), Wi-Fi, or 5G communication module. The BT/BLE module can wirelessly couple to BT/BLE compatible devices including passenger wireless mobile communication devices (e.g., smartphones/tablets) or the vehicle's instrument panel interface (e.g., the vehicles instrument display or infotainment system). The vehicle's driver and passengers can perform additional control tasks using for example a phone application communicating with the embedded BT/BLE module. The control tasks can include, for example, changing the intensity, luminosity, or brightness of the LEDs, enabling certain color LEDs or certain color configurations, and creating customized effects such as strobing with different strobe periodicity. Additionally, or alternatively, the electronic components 122 or the receiver PCB 124 can include actuators or sensors that can be controlled and/or monitored remotely via the BT/BLE communication or other wireless communication protocol (e.g., Wi-Fi). For example, temperature sensors or tire pressure sensors can report temperature or tire pressure to the handheld electronic devices or the vehicle dash display console via the wireless communication interface. In some implementations, the BT/BLE module can be disposed on the receiver side (e.g., in the wheel trim or wheel rim of the vehicle wheel) and can be configured to receive power either directly from the wireless power receiver (e.g., the regulated output) or from the battery buffer coupled to the wireless power receiver.

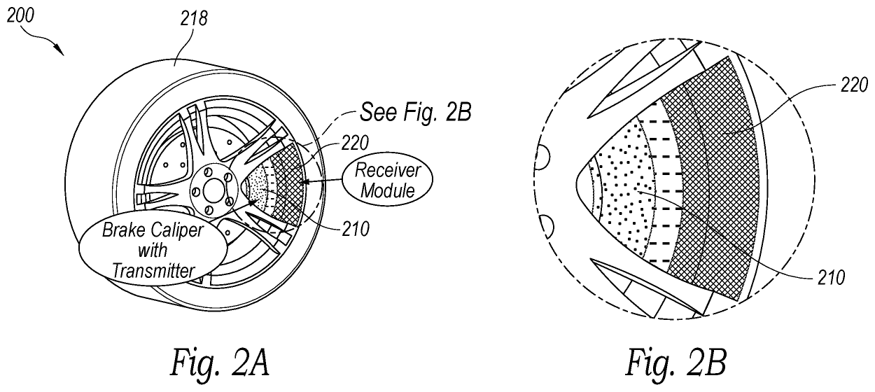

FIG. 2A illustrates a vehicle wheel structure 200 containing a wireless power system (e.g., wireless power system 100 of FIG. 1). The vehicle wheel structure 200 includes a movable or rotatable wheel portion 218 (e.g., the wheel including the tire and rim) and a fixed portion (e.g., the brake pads and brake calipers). A base/fixed wireless transmitter unit or magnetic field generator (e.g., fixed transmitter 110 in FIG. 1) can be mounted on the brake calipers 210 and a wireless power receiver 220 (e.g., movable receiver 120 in FIG. 1) can be mounted as an exterior wheel trim part of the movable wheel portion 218. In some implementations, the movable wheel portion 218 can include more than one wireless power receiver 220 arranged along the circumference of the wheel (e.g., receiver coils covering the entire rim or only certain portions of the rim). In some implementations, the base/fixed unit, transmitter unit or magnetic field generator (e.g., the permanent magnet) can be located in the wheel well, attached to the brake calipers, located in the brake calipers, or attached near or on the knuckle. The magnetic field generator or transmitter unit can also be injection molded directly into the wheel well. The wireless power receiver can be completely independent of other vehicle electronics (e.g., a permanent magnet not receiving power from vehicle wiring harness). FIG. 2B is an exploded view of a portion of the vehicle wheel structure of FIG. 2A showing the brake calipers 210 containing or near the based/fixed wireless transmitter module (e.g., permanent magnet or electromagnet) and the wireless power receiver 220 in the movable or rotatable portion.

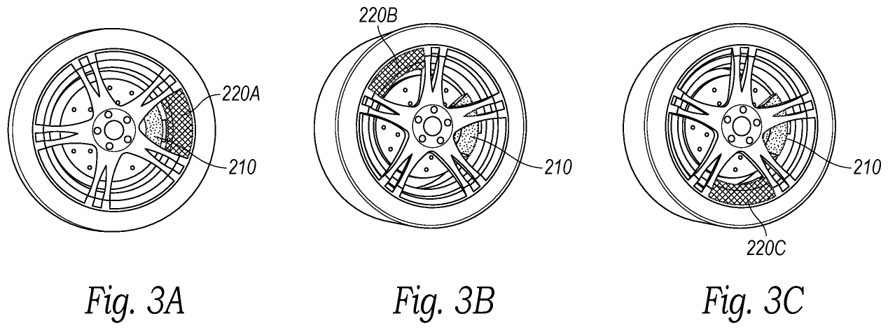

FIGS. 3A, 3B, and 3C illustrate a vehicle wheel structure showing different positions of a wireless power receiver in relation to a magnetic field generator as the wheel rotates. For example, in FIG. 3A the wireless power receiver is at first position aligned to the magnetic field generator mounted on the brake calipers 210, and in FIGS. 3B and 3C, the wireless power receiver is at positions 220B and 220C offset from the position of the brake calipers 210 containing or near the transmitter. As can be seen in FIGS. 3A-3C, the magnetic field generator remains at a fixed and stationary position as the wheel rotates. A maximum electromotive force (EMF) across the receiver antenna is generated when the alignment of the magnetic field generator and receiver is at the positions of the brake calipers 210 and the wireless power receiver 220A as shown in FIG. 3A when the wireless power receiver 220A cross the magnetic flux generated by the magnetic field generator.

As the wheel rotates, the wireless power receiver crosses the path of the static field produced by the magnetic field generator mounted (e.g., the magnetic field emanating from the transmitter module mounted on the brake calipers). This induces an EMF across the receiver antenna(s). The EMF is rectified (e.g., by a bridge rectifier in receiver PCB 124 in FIG. 1) and used to power electronic components, e.g., electronic components in the wheel including LEDs and a battery.

When the alignment of the magnetic field generator and receiver is at the positions of the brake calipers 210 and the wireless power receiver 220A as shown in FIG. 3A, the maximum inductive coupling and flux captured between the magnetic field generator and receiver occurs. This is achieved when the receiver antennas are approximately parallel to the power transmitter (e.g., parallel to the permanent magnet or electromagnet in the power transmitter). If the receiver antennas are not approximately parallel to the flux lines from the permanent magnet when the receiver antennas are passing next to the fixed transmitter, the power delivered to the wireless power receiver will be less than a maximum power that could be delivered. Additionally, the maximum inductive coupling can be achieved when the transmitter (e.g., the permanent magnet) is closest to the receiver (e.g., the receiver antenna(s)) such as within a few inches (e.g., less than 6 inches) of each other. The magnetic field generator and receiver can be compared to a miniature alternator where the magnetic field generator is like a stator, and the wireless power receiver(s) are like the armatures.

The strength of the permanent magnet in the magnetic field generator and the number of windings of the receiver antenna(s) (including the number of receivers embedded in the wheel) can be determined based on a performance vs cost tradeoff. For example, stronger permanent magnets and a larger number of receivers and/or receiver antenna coils/windings create a larger induced EMF which can increase the power delivered to the loads (the electronic components). However, this can lead to a more costly wireless power system.

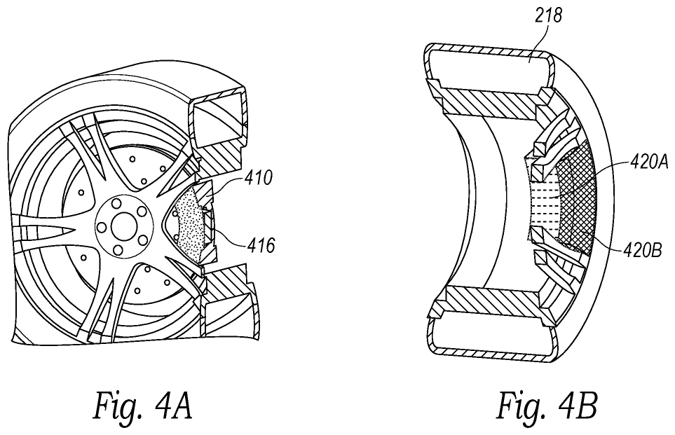

FIG. 4A illustrates a vehicle wheel structure showing a magnetic field generator 416 embedded on or in wheel calipers 410.

FIG. 4B illustrates a vehicle wheel structure showing a wireless power receiver embedded in a vehicle's wheel rim. In some implementations, the wireless power receiver can include a receiver antenna 420A (or multiple receiver antennas) and a receiver PCB 420B. The receiver PCB 420B can include other electronics including a battery buffer and one or more LEDs. In some implementations, the LEDs and battery can be positioned at a different part of the movable wheel portion 218.

Because the transmitter and receiver modules do not need to be physically wired to the harness of the vehicle, the disclosed technology can operate as an independent system from the other power electronics in the vehicle.

The transmitter and receiver modules can be mounted as aftermarket products via, for example, plastic inserts built inside an injection mold of the modules, magnetic induction, or the modules can be screwed onto, bolted, or fastened into the wheel rim, wheel well, brake calipers, or knuckle. Additionally, the power system or charging system can be embedded into the vehicle parts directly (e.g., into the brake calipers, knuckle, wheel well, or vehicle wheel) by vehicle OEMs as an integrated wireless power solution. To prevent misalignment between the power transmitter and power receiver, inserts on the wheel (e.g., power receiver injection molded directly into the wheel) can be used as alignment guides, e.g., for different aftermarket components. The relative position of the power transmitter and receiver can be varied for different rim and wheel sizes to ensure that the transmitter is always parallel to and closest to the receiver as the wheel rotates and repeatedly brings the receiver in proximity to the transmitter.

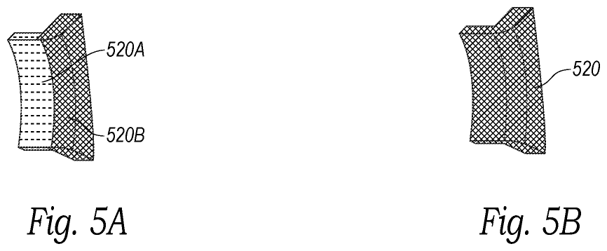

FIG. 5A illustrates a wireless power receiver comprising two joined constituent parts, a receiver antenna 520A and a receiver PCB 520B. The receiver PCB can include the battery buffer and LEDs or these can be in a different conjoined or disjoint part (not shown in FIG. 5A).

FIG. 5B illustrates a wireless power receiver comprising a single part. In some implementations, the receiver antenna, receiver PCB, battery buffer, LEDs, and other electronics are integrated into a single part 520 for additional robustness and sturdiness. The single part 520 can be fabricated via a single injection mold that houses all the components for the wireless power receiver.

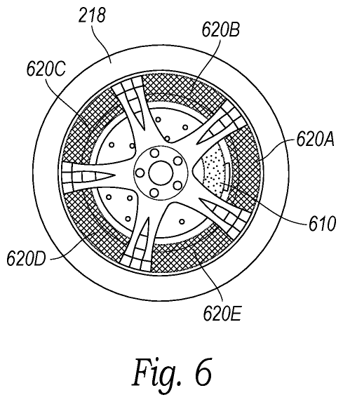

FIG. 6 illustrates a vehicle wheel structure containing multiple wireless power receivers 620A-620E. In some implementations, the multiple power receivers 620A-620E can be integrated or embedded in each trim part of the movable wheel portion 218 as shown in FIG. 6. In other implementations, multiple receiver antennas can be coupled to a single wireless power receiver (e.g., multiple receiver antennas 126 in FIG. 1, electrically coupled to a single receiver PCB 124). This can be particularly beneficial for a direct (OEM) integration rather than as an aftermarket product because, by consolidating multiple modules or parts together (e.g., multiple batteries into a single battery), there can be a greater production cost saving. For an aftermarket product, it may be more desirable to have multiple modular, independent parts to provide flexibility for different wheel sizes, wheel rims, and OEM brands.

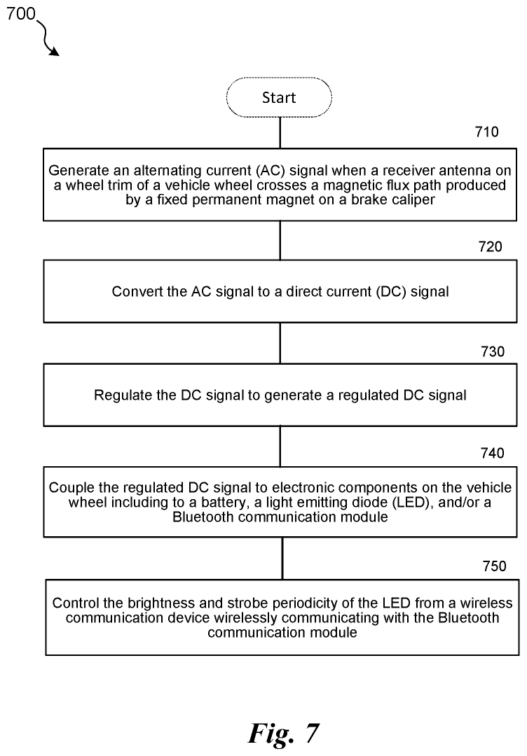

FIG. 7 is a flowchart 700 that illustrates generating power for electronic components in a vehicle wheel using a wireless power receiver coupled to a magnetic field generator. At block 710, the wireless power receiver generates an alternating current (AC) signal when a receiver antenna or receiver antennas on a wheel trim or a wheel rim of a vehicle crosses a magnetic flux path produced by the magnetic field generator. The magnetic field generator can be disposed in the wheel well, knuckle, or on or near the brake calipers.

At block 720, the wireless power receiver converts the AC signal to a direct current (DC) signal, e.g., using a bridge rectifier in a receiver printed circuit board (PCB) of the wireless power receiver.

At block 730, the wireless power receiver regulates the DC signal to generate a regulated DC signal (e.g., a DC signal independent on the angular velocity of the wheel).

At block 740, the wireless power receiver couples the regulated DC signal to electronic components on the vehicle wheel. Electronic components can include, for example, a battery, light emitting diodes (LEDs), and/or BT, BLE, LTE, Wi-Fi, or 5G communication modules.

At block 750, a user device (e.g., a wireless communication device such as a laptop, tablet, smartphone) or the vehicle's infotainment system can be used to wirelessly control the electronic components via wireless communication with a Bluetooth component in the vehicle wheel. For example, the Bluetooth communication (or other wireless communication protocol) can be used to adjust the brightness/intensity of the LEDs, types of LEDs and colors that are active (e.g., color of LEDs illuminated), the strobe periodicity of the LEDs, other visual effects, etc.

It will be appreciated that the disclosed technology is applicable to a vehicle with any number of wheels including four-wheel personal vehicles, trucks, tractors; multi-wheel trailers; two-wheel or three-wheel motorcycles, bicycles, tricycles etc. Because the wireless power system operates independently from the vehicle's power source, vehicle's with little to no electric power source can be configured to use this wireless power system.

For two-wheel or three-wheel vehicles (e.g., bicycles, motorcycles, etc.), the mounting location of the transmitter and receiver module(s) can be selected based on the unique structures of the vehicle. The transmitter module is usually mounted in a fixed position such that, as the receiver antenna(s) pass the transmitter position, the transmitter is within a few inches of the receiver antenna(s) (e.g., less than about 6 inches). The transmitter and the receivers (e.g., receiver antennas) are mounted parallel to each other to maximize the flux linkage which maximizes the induced EMF and the power delivered to the electronics coupled to the wireless power receiver. The power transmitter and receivers can be mounted as aftermarket accessories or integrated directly into the two/three-wheel vehicle's parts by the OEM (e.g., in the forks, brake calipers, chain stay, etc.). Like in four-wheel vehicles, the disclosed technology provides integration flexibility because of the system independence (e.g., independence of transmitter at fixed location and receiver in movable portion of the apparatus and independent of transmitter from other power sources).

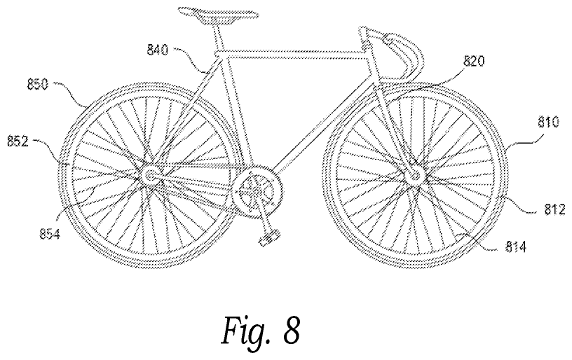

For example, FIG. 8 illustrates an example bicycle structure for use with the disclosed wireless power system. In a standard track bicycle there are several potential power transmitter mounting positions such as on or near the fork-side bars 820 for the front wheel 810 and on or near the chain stay 830 and seat stay 840 for the back wheel 850. The power receiver module(s) (or receiver antenna(s)) can be mounted on or near the wheel rim (e.g., front rim 812 or rear rim 852) or wheel spokes (e.g., front wheel spokes 814 or rear rim spoke 854).

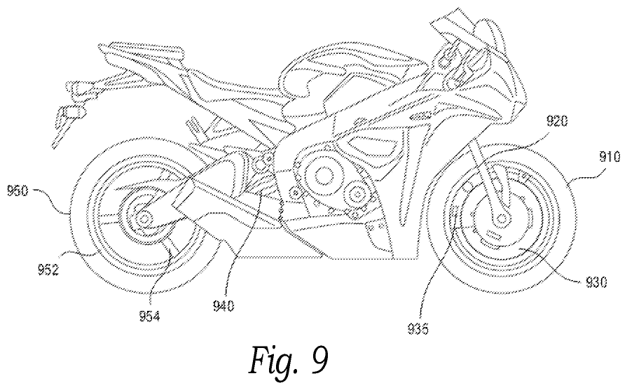

FIG. 9 illustrates an example motorcycle structure for use with the disclosed wireless power system. For a motorcycle, the power transmitter can be mounted on or near the forks 920 for the front wheel 910 and on or near the footrest 940. In some implementations, the transmitter can be mounted on or near the motorcycle brake calipers 935 located near a rotor 930 on the front wheel 910 and/or back wheel 950 (brake calipers and rotors on back wheel not shown in FIG. 9). The power receiver (or receiver antenna(s)) can be located on or near the wheel spokes 954 or wheel rim 952 of the back wheel 950 or the front wheel 910.

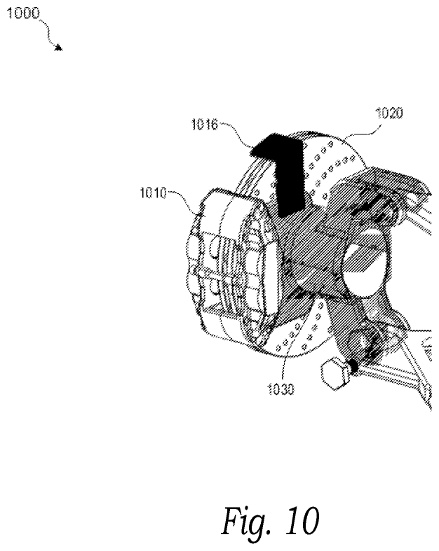

FIG. 10 illustrates an example mounting of a wireless power transmitter 1016 in the knuckle region 1030 of a vehicle. The wireless power transmitter 1016 can be bolted or otherwise attached to the knuckle region 1030 of the vehicle or on other fixed/stationary portion of the vehicle near the wheel, e.g., on or near the brake caliper 1010. As described above, the wireless power transmitter 1016 can be a wireless charging transmitter device, a magnetic field generator such as a permanent magnet or electromagnet, or any base/fixed unit capable of inducing power to a wireless receiver (not shown in FIG. 10). Label 1020 in FIG. 10 shows the brake disk.

Some preferred embodiments may incorporate the following technical solutions.

According to one solution, a wireless power system includes a wireless power receiver disposed on a wheel rim or a wheel trim of a vehicle wheel. The wireless power receiver comprises one or more receiver antennas and a receiver PCB coupled to the one or more receiver antennas. The receiver PCB comprises a bridge rectifier configured to convert an alternating current (AC) signal to a direct current (DC) signal, a regulator, and a controller; and one or more electronic components coupled to the wireless power receiver and configured to receive power from the wireless power receiver. Some example implementations are described with reference to FIGS. 1 to 6. As disclosed herein, the controller may be a processor or a microprocessor with and internal or external memory. The controller may perform tasks such as controlling amount of wireless power, reporting received wireless transmission power, receiving wireless messages, transmitting wireless messages, and so on.

In some embodiments, the one or more electronic components comprises an energy storage device or one or more light emitting diodes (LEDs).

In some embodiments, the receiver PCB includes a converter that has the following type: a flyback, a buck, a buck-boost, a sepic (single ended primary inverter converter) and may further include a voltage regulator, and/or a current monitoring unit. As disclosed throughout the present document, the voltage regulator or the current monitoring unit may be used to regulate voltage or monitor generated current which may be used to provide a reading to the user of the vehicle, or a way by which a technician may be able to do diagnostic testing during installation or repair. In some embodiments, the voltage regulator and current monitoring units may be used to provide a feedback signal that limits the operation of the power transfer.

In some embodiments, the above solution further includes a fixed unit disposed on or near a brake caliper or knuckle of the vehicle wheel, wherein the fixed unit is encapsulated in an enclosure adapted to protect the fixed unit from one or more environmental hazards, and wherein the fixed unit is configured to induce an electromotive force on the one or more receiver antennas in response to the one or more receiver antennas crossing a magnetic flux path produced by the fixed unit. The fixed unit may be fixed in the sense that it does not move or rotate relative to the receiver side.

In some embodiments, the energy storage device comprises a battery. In some embodiments, the energy storage device comprises a capacitor. One beneficial advantage of a capacitor is that, unlike a rechargeable battery, no replacement may be needed during the lifetime of use of the wireless charging system.

In some embodiments, the fixed unit comprises a wireless transmitter or a magnetic field generator and wherein the magnetic field generator comprises a permanent magnet or an electromagnet.

In some embodiments, the battery is configured to provide power to the one or more electronic components when the vehicle wheel is not rotating. In some embodiments, the battery is configured to provide a constant current to the one or more electronic components independent of an angular velocity of the vehicle wheel.

In some embodiments, the above technical solution further includes a communication module configured to monitor or control the one or more electronic components through a wireless communication device. The wireless communication device comprises a mobile communication device or a vehicle infotainment system. The communication module may be disposed on a wheel rim or wheel trim of the vehicle wheel. The communication module may include a processor, a memory and a transmitter. In some embodiments, the communication module may include receiver that is configured to allow pairing of the communication module with another in-vehicle communication system for performing interactive tasks such as control and monitoring.

In some embodiments, the communication module includes a Bluetooth-, Bluetooth Low Energy (BLE)-, Long-Term Evolution (LTE)-, Wi-Fi-, or 5G-based communication module.

In some embodiments, the communication module is configured to receive power from the wireless power receiver or from the energy storage device.

In some embodiments, the communication module is further configured to control intensity, luminosity, or strobe periodicity of the one or more light emitters such as LEDs.

In some embodiments, the vehicle is a motorcycle and wherein the wireless power system further comprises a fixed unit disposed near a front wheel fork, a foot rest, or a brake caliper, and wherein the fixed unit comprises a wireless transmitter or a magnetic field generator.

Another solution includes a method (e.g., depicted with reference to FIG. 7) implemented on a wireless power receiver for supplying power to one or more electronic components disposed on or in a vehicle wheel. The method includes generating an alternating current (AC) signal in response to a receiver antenna crossing a magnetic flux path produced by a magnetic field generator; converting, by a bridge rectifier disposed in a receiver printed circuit board (PCB), the AC signal to a direct current (DC) signal; and regulating the DC signal to generate a regulated DC signal, wherein the regulated DC signal is coupled to the one or more electronic components.

In some embodiments, the one or more electronic components comprises an energy storage device or one or more light emitting diodes (LEDs).

In some embodiments, the energy storage device comprises a battery or a capacitor.

In some embodiments, the receiver antenna is embedded in a trim of the vehicle wheel.

In some embodiments, the magnetic field generator comprises a fixed permanent magnet or an electromagnet encapsulated in an enclosure adapted to protect the fixed permanent magnet or the electromagnet from one or more environmental hazards.

In some embodiments, the energy storage device is configured to provide power to the one or more electronic components when the vehicle wheel is not rotating and independent of an angular velocity of the vehicle wheel when it is rotating.

Another technical solution includes a wireless charging system that includes a wireless power receiver disposed on a wheel rim or a wheel trim of a vehicle wheel, wherein the wireless power receiver comprises one or more receiver antennas and a receiver PCB coupled to the one or more receiver antennas, wherein the receiver PCB comprises a bridge rectifier configured to convert an alternating current (AC) signal to a direct current (DC) signal, a regulator, and a controller; one or more electronic components coupled to the wireless power receiver and configured to receive power from the wireless power receiver; and a wireless power transmitter disposed on or near a brake caliper, knuckle, or wheel well of the vehicle wheel, wherein the wireless power transmitter comprises a fixed permanent magnet or electromagnet encapsulated in an enclosure adapted to protect the fixed permanent magnet or electromagnet from one or more environmental hazards, and wherein the wireless power transmitter is configured to induce an electromotive force on the one or more receiver antennas in response to the one or more receiver antennas crossing a magnetic flux path produced by the wireless power transmitter.

In various embodiments, the wireless charging system of this solution may incorporate various features described with respect to the first technical solution.

In the above-disclosed solutions, a PCB include a traditional single layer or multi-layer printed circuit board, an arrangement of discrete component, a system on chip (single silicon die solution) or a combination thereof.

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

I/We claim:

1. A wireless power system, comprising:
a wireless power receiver disposed on a wheel rim or a wheel trim of a vehicle wheel,
wherein the wireless power receiver comprises one or more receiver antennas and a receiver printed circuit board, PCB, coupled to the one or more receiver antennas,
wherein the receiver PCB comprises a bridge rectifier configured to convert an alternating current (AC) signal to a direct current (DC) signal, a regulator, and a controller; and
one or more electronic components coupled to the wireless power receiver and configured to receive power from the wireless power receiver.

2. The wireless power system of claim 1, wherein the one or more electronic components comprises an energy storage device or one or more light emitting diodes (LEDs).

3. The wireless power system of claim 1, whereby the receiver PCB includes a flyback, buck, buck-boost, sepic, voltage regulator, and/or current monitoring unit.

4. The wireless power system of claim 1, further comprising:
a fixed unit disposed on or near a brake caliper or knuckle of the vehicle wheel,
wherein the fixed unit is encapsulated in an enclosure adapted to protect the fixed unit from one or more environmental hazards, and
wherein the fixed unit is configured to induce an electromotive force on the one or more receiver antennas in response to the one or more receiver antennas crossing a magnetic flux path produced by the fixed unit.

5. The wireless power system of claim 2, wherein the energy storage device comprises a battery or a capacitor.

6. The wireless power system of claim 4, wherein the fixed unit comprises a wireless transmitter or a magnetic field generator and wherein the magnetic field generator comprises a permanent magnet or an electromagnet.

7. The wireless power system of claim 5, wherein the battery is configured to provide power to the one or more electronic components when the vehicle wheel is not rotating.

8. The wireless power system of claim 5, wherein the battery is configured to provide a constant current to the one or more electronic components independent of an angular velocity of the vehicle wheel.

9. The wireless power system of claim 2, further comprising:
a communication module configured to monitor or control the one or more electronic components through a wireless communication device,
wherein the wireless communication device comprises a mobile communication device or a vehicle infotainment system, and
wherein the communication module is disposed on a wheel rim or wheel trim of the vehicle wheel.

10. The wireless power system of claim 9, wherein the communication module includes a Bluetooth-, Bluetooth Low Energy (BLE)-, Long-Term Evolution (LTE)-, Wi-Fi-, or 5G-based communication module.

11. The wireless power system of claim 9, wherein the communication module is configured to receive power from the wireless power receiver or from the energy storage device.

12. The wireless power system of claim 9, wherein the communication module is further configured to control intensity, luminosity, or strobe periodicity of the one or more LEDs.

13. The wireless power system of claim 1, wherein the vehicle is a motorcycle and wherein the wireless power system further comprises a fixed unit disposed near a front wheel fork, a foot rest, or a brake caliper, and wherein the fixed unit comprises a wireless transmitter or a magnetic field generator.

14. A method implemented on a wireless power receiver for supplying power to one or more electronic components disposed on or in a vehicle wheel, the method comprising:
generating an alternating current (AC) signal in response to a receiver antenna crossing a magnetic flux path produced by a magnetic field generator;
converting, by a bridge rectifier disposed in a receiver printed circuit board (PCB), the AC signal to a direct current (DC) signal; and
regulating the DC signal to generate a regulated DC signal, wherein the regulated DC signal is coupled to the one or more electronic components.

15. The method of claim 14, wherein the one or more electronic components comprises an energy storage device or one or more light emitting diodes (LEDs).

16. The method of claim 15, wherein the energy storage device comprises a battery or a capacitor.

17. The method of claim 14, wherein the receiver antenna is embedded in a trim of the vehicle wheel.

18. The method of claim 14, wherein the magnetic field generator comprises a fixed permanent magnet or an electromagnet encapsulated in an enclosure adapted to protect the fixed permanent magnet or the electromagnet from one or more environmental hazards.

19. The method of claim 15, wherein the energy storage device is configured to provide power to the one or more electronic components when the vehicle wheel is not rotating and independent of an angular velocity of the vehicle wheel when it is rotating.

20. A wireless charging system, comprising:
a wireless power receiver disposed on a wheel rim or a wheel trim of a vehicle wheel,
wherein the wireless power receiver comprises one or more receiver antennas and a receiver printed circuit board, PCB, coupled to the one or more receiver antennas,
wherein the receiver PCB comprises a bridge rectifier configured to convert an alternating current (AC) signal to a direct current (DC) signal, a regulator, and a controller;
one or more electronic components coupled to the wireless power receiver and configured to receive power from the wireless power receiver; and
a wireless power transmitter disposed on or near a brake caliper, knuckle, or wheel well of the vehicle wheel,
wherein the wireless power transmitter comprises a fixed permanent magnet or electromagnet encapsulated in an enclosure adapted to protect the fixed permanent magnet or electromagnet from one or more environmental hazards, and
wherein the wireless power transmitter is configured to induce an electromotive force on the one or more receiver antennas in response to the one or more receiver antennas crossing a magnetic flux path produced by the wireless power transmitter.
